(19) United States
(12) Patent Application Publication
(10) Pub. No.: US 2024/0055173 A1
(43) Pub. Date: Feb. 15, 2024

(54) TRANSFORMER

(71) Applicant: Hitachi, Ltd., Tokyo (JP)

(72) Inventors: Kimihisa FURUKAWA, Tokyo (JP); Akihiko KANOUDA, Tokyo (JP); Yuuichi MABUCHI, Tokyo (JP); Mizuki NAKAHARA, Tokyo (JP); Hideaki TANAKA, Tokyo (JP)

(73) Assignee: Hitachi, Ltd., Tokyo (JP)

(21) Appl. No.: 18/268,820

(22) PCT Filed: Sep. 27, 2021
(86) PCT No.: PCT/JP2021/035347

§ 371 Date: Jun. 21, 2023

(30) Foreign Application Priority Data
Jan. 8, 2021 (JP) 2021-001934

(51) Int. Cl. H01F 27/28

(52) U.S. Cl. CPC H01F 27/28; H01F 30/10

(57) ABSTRACT

The present invention provides a transformer having a high degree of design freedom for adjusting leakage inductance, while conforming to arrangement constraints between components in order to ensure the insulating properties of the transformer. This transformer has a core formed of a magnetic body, a primary coil wound around the core and being connected to a high-voltage side, the primary coil having two coil layers of an inner primary coil and an outer primary coil arranged more toward an outer peripheral side than the inner primary coil, and a second primary coil wound around the core and connected to a low-voltage side, the outer primary coil being arranged offset with respect to the inner primary coil in the longitudinal direction of the axis of the core.

### TECHNICAL FIELD

The present invention relates to a transformer that constitutes a part of a power conversion device.

### BACKGROUND ART

In recent years, electrification has been accelerated in various fields. In particular, progress of electrification of a moving body (for example, an automobile, an aircraft, a construction machine, a ship, or the like) and electrification in introduction of renewable energy is remarkable, and demand for power conversion devices used for these is increasing.

As the demand for power conversion devices is increased, the performance required for power conversion devices is also increased. The performance required for power conversion devices is, of course, improvement of input and output characteristics and high efficiency of AC/DC, which are basic performance, as well as size reduction, weight reduction, high reliability, multiple input and output, high voltage, and mounting of a storage function. The demand for power conversion devices capable of meeting the performance required for such power conversion devices will be increased in the future.

In applications where the installation space is limited, it is particularly effective to reduce the size of the transformer constituting a part of the power conversion device.

As a technology for realizing the size reduction, a solid state transformer (power conversion device) (SST in the following) has been proposed. The SST includes a converter that converts a commercial frequency voltage into a radio frequency voltage of several kHz to several 100 kHz, a transformer driven by the converter at a radio frequency, and an inverter that generates a voltage of an arbitrary frequency or an arbitrary amplitude from an output of the transformer. The transformer driven at a radio frequency can be significantly reduced in size and weight as compared with the commercial transformer in the related art.

In a case where the SST is used in a high-voltage device such as a grid interconnection device, since a high voltage of several kV with respect to the ground potential is superimposed on a coil connected to the high-voltage side (hereinafter, primary coil), it is necessary to ensure the insulating properties between the primary coil and a coil connected to the low-voltage side (hereinafter, second primary coil).

As a background art in such a technology in the related art, there is JP 2019-87663 A (hereinafter, PTL 1). PTL 1 describes a transformer including a core having a first leg portion and a second leg portion, cylindrical first and third coils arranged in the first leg portion, and cylindrical second and fourth coils arranged in the second leg portion, in which the first coil, the second coil, the third coil, and the fourth coil are formed of litz wire, the first coil and the second coil are connected in parallel, the third coil and the fourth coil are connected in series, the first coil and the second coil have the same number of windings, the same shape, and the same size, and the third coil and the fourth coil have the same number of windings, the same shape, and the same size.

### CITATION LIST

### Patent Literature

PTL 1: JP 2019-87663 A

### SUMMARY OF INVENTION

### Technical Problem

PTL 1 describes a transformer including cylindrical first and third coils arranged in a first leg portion, and cylindrical second and fourth coils arranged in a second leg portion.

In general, in a transformer, a potential difference between a primary coil (usually on a high-potential side) and a second primary coil (usually on a low-potential side) is increased, and it is necessary to ensure the insulating properties between the primary coil and the second primary coil. In particular, the transformer constituting the SST needs to be designed to have a desired leakage inductance in order to reduce the switching loss in relation to the converter and the inverter constituting the SST.

However, PTL 1 does not describe a transformer having a large degree of design freedom for adjusting the leakage inductance while conforming to arrangement constraints between components in order to ensure the insulating properties of the transformer.

Therefore, the present invention provides a transformer having a large degree of design freedom for adjusting the leakage inductance while conforming to arrangement constraints between components in order to ensure the insulating properties of the transformer.

### Solution to Problem

In order to solve the problems described above, a transformer of the present invention includes a core formed of a magnetic body; a primary coil wound around the core and connected to a high-voltage side, the primary coil having two coil layers of an inner primary coil and an outer primary coil arranged more toward an outer peripheral side than the inner primary coil; and a second primary coil wound around the core and connected to a low-voltage side, in which the outer primary coil is arranged offset with respect to the inner primary coil in a longitudinal direction of an axis of the core.

### Advantageous Effects of Invention

According to the present invention, it is possible to provide a transformer having a large degree of design freedom for adjusting the leakage inductance while conforming to arrangement constraints between components in order to ensure the insulating properties of the transformer.

Problems, configurations, and effects other than those described above will be clarified by the following description of embodiments.

### BRIEF DESCRIPTION OF DRAWINGS

FIG. 1 is an explanatory diagram for describing a vertical cross section of a transformer 10 described in Embodiment 1.

FIG. 2 is an explanatory diagram for describing a vertical cross section of a transformer 10 described in Embodiment 2.

### DESCRIPTION OF EMBODIMENTS

Hereinafter, embodiments of the present invention will be described with reference to the drawings. Note that substantially the same or similar configurations are denoted by the same reference numerals, and in a case where descriptions thereof overlap, the description thereof may be omitted.

The transformer 10 described below is a state in which main components constituting the transformer 10 are incorporated.

### Embodiment 1

First, a vertical cross section of the transformer 10 described in Embodiment 1 will be described.

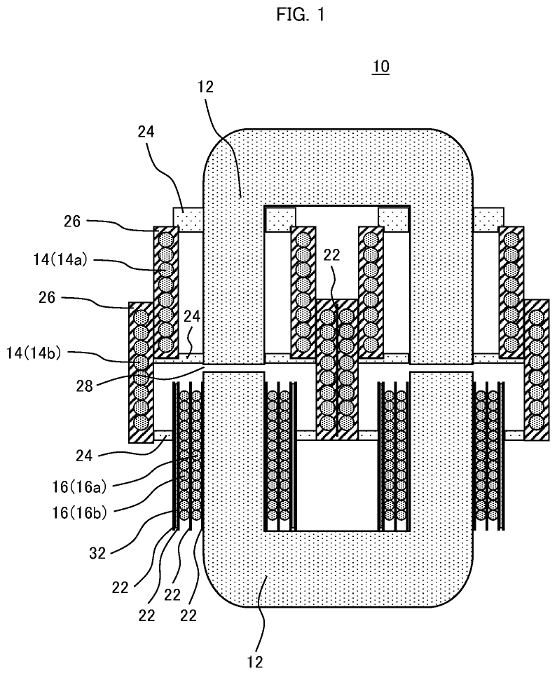

FIG. 1 is an explanatory diagram for describing the vertical cross section of the transformer 10 described in Embodiment 1.

The transformer 10 has two cores (magnetic cores) 12, a positive U-shaped lower portion and an inverse U-shaped upper portion. The lower portion core (first core) 12 and the upper portion core (second core) 12 are arranged to face each other, and a window is formed in a space surrounded by the lower portion core 12 and the upper portion core 12, that is, an inside between the lower portion core 12 and the upper portion core 12. A gap (core cavity) 28 is formed between the lower portion core 12 and the upper portion core 12. That is, the core 12 has the lower portion core 12 and the upper portion core 12 that are arranged facing each other to form the gap 28.

The core 12 is formed of ferrite, for example. The core 12 is not limited to ferrite, and may be formed of another magnetic body.

Furthermore, the transformer 10 has a primary coil 14 (high-potential side) connected to the high-voltage side and formed of copper, and a second primary coil 16 (low-potential side) connected to the low-voltage side and formed of copper. The primary coil 14 has at least two or more coil layers, and the second primary coil 16 has at least one or more coil layers. The primary coil 14 and the second primary coil 16 are arranged in a vertically divided manner. The primary coil 14 has a relatively high potential with respect to the second primary coil 16, and the second primary coil 16 has a relatively low potential with respect to the primary coil 14.

The second primary coil 16 is arranged by being wound in a cylindrical shape around a columnar portion (axial center portion) of the core 12 so as to penetrate the window of the core 12. The second primary coil 16 has an inner second primary coil (coil layer) 16a formed on the inner side and an outer second primary coil (coil layer) 16b formed on the outer side with respect to the core 12. The two second primary coils 16 are arranged in parallel.

A contact preventing material 32 formed of copper is arranged on the outer side of the outer second primary coil 16b. The contact preventing material 32 prevents the contact between the primary coil 14 and the second primary coil 16, and protects the second primary coil 16.

An insulating material 22 formed of a resin sheet, insulating paper (NOMEX), or the like is arranged between the core 12 and the inner second primary coil 16a, between the inner second primary coil 16a and the outer second primary coil 16b, between the outer second primary coil 16b and the contact preventing material 32, and on the outer side of the contact preventing material 32. In this manner, the insulating properties (electrical insulation) between the core 12 and the inner second primary coil 16a, between the inner second primary coil 16a and the outer second primary coil 16b, between the outer second primary coil 16b and the contact preventing material 32, and between the contact preventing material 32 and the primary coil 14 are ensured.

Further, the second primary coil 16 is arranged by being wound around a columnar portion of the lower portion core 12. That is, the second primary coil 16 is arranged on the lower side of (below) the gap 28 formed between the lower portion core 12 and the upper portion core 12.

In Embodiment 1, the inner second primary coil 16a and the outer second primary coil 16b have the same number of windings and the same cross-sectional area. Further, in Embodiment 1, the inner second primary coil 16a and the outer second primary coil 16b have the same length in an up and down direction (longitudinal direction of the axis of the core 12) thereof.

The primary coil 14 is arranged by being wound in a cylindrical shape around a columnar portion (axial center portion) of the core 12 so as to penetrate the window of the core 12. The primary coil 14 has an inner primary coil (coil layer) 14a formed on the inner side and an outer primary coil (coil layer) 14b formed on the outer side with respect to the core 12.

The inner primary coil 14a is covered with a resin material 26 in order to ensure the insulating properties of the inner primary coil 14a, and the outer primary coil 14b is covered with the resin material 26 in order to ensure the insulating properties of the outer primary coil 14b.

The inner primary coil 14a is arranged by being wound around the columnar portion of the core 12 so as to form a cavity between the inner primary coil 14a and the core 12 via a support member 24 formed of resin, insulating paper, or the like. That is, the support member 24 that forms a cavity between the inner primary coil 14a and the core 12 is arranged between the inner primary coil 14a and the core 12.

The inner primary coil 14a is supported by two support members 24, that is, the support member 24 at the center (above the gap 28 and in the vicinity of the gap 28) and the support member 24 on the upper side (above the center). The center support member 24 and the upper support member 24 are arranged in the upper portion core 12.

By forming a cavity between the inner primary coil 14a and the core 12, the cavity serves as an electric field relaxation layer, and suppresses partial discharge. The cavity serves as an air passage, and cools the inner primary coil 14a. Further, the cavity suppresses fanning heat due to mutual heat generation between the inner primary coil 14a and the core 12 (heat generation due to leakage flux in the gap 28), and solves heat dissipation.

Further, the inner primary coil 14a is arranged by being wound around the columnar portion of the upper portion core 12. That is, the inner primary coil 14a is arranged on the upper side of (above) the gap 28.

The outer primary coil 14b is arranged so as to form a cavity between the outer primary coil 14b and the outer second primary coil 16b via the support member 24 at the center and the support member 24 on the lower side (below the center) arranged in the insulating material 22 formed on the outer side of the contact preventing material 32. That is, the lower support member 24 that forms a cavity between the outer primary coil 14b and the outer second primary coil 16b is arranged between the outer primary coil 14b and the outer second primary coil 16b.

The outer primary coil 14b is supported by two support members 24, that is, the center support member 24 and the lower support member 24.

Thereby, the cavity serves as an electric field relaxation layer, and suppresses partial discharge. Further, the cavity serves as an air passage, and cools the outer second primary coil 16b. Further, the cavity suppresses fanning heat due to mutual heat generation between the outer primary coil 14b and the outer second primary coil 16b (heat generation due to leakage flux in the gap 28), and solves heat dissipation.

The outer primary coil 14b is arranged on the outer peripheral side of the gap 28 so as to straddle the gap 28, is arranged on the outer peripheral side of the inner primary coil 14a, and is arranged on the outer peripheral side of the second primary coil 16.

In Embodiment 1, the inner primary coil 14a and the outer primary coil 14b have the same number of windings and the same cross-sectional area. Further, in Embodiment 1, the inner primary coil 14a and the outer primary coil 14b have the same length in the up and down direction (longitudinal direction of the axis of the core 12) thereof.

The resin material 26 covering the outer primary coil 14b and the resin material 26 covering the inner primary coil 14a are arranged to be in contact with each other.

Further, the inner primary coil 14a and the outer primary coil 14b are arranged by deviating (offset) from each other in the up and down direction (longitudinal direction of the axis of the core 12). The outer primary coil 14b is arranged by deviating from the inner primary coil 14a in the downward direction of the axis of the core 12.

That is, the lower end of the outer primary coil 14b is arranged below the lower end of the inner primary coil 14a arranged above the gap 28, and is arranged below the gap 28. The upper end of the outer primary coil 14b is arranged above the lower end of the inner primary coil 14a.

As a result, an overlapping portion (contact area) between the inner primary coil 14a and the outer primary coil 14b is formed, and the overlapping portion between the inner primary coil 14a and the outer primary coil 14b can be adjusted by adjusting the arrangement positions of the inner primary coil 14a and the outer primary coil 14b.

The leakage inductance of the transformer 10 can be adjusted by adjusting the overlapping portion (offset amount) between the inner primary coil 14a and the outer primary coil 14b. The larger the overlapping portion between the inner primary coil 14a and the outer primary coil 14b (the smaller the deviation), the larger the leakage inductance, and the smaller the overlapping portion between the inner primary coil 14a and the outer primary coil 14b (the larger the deviation), the smaller the leakage inductance.

As a result, it is possible to provide the transformer 10 having a large degree of design freedom for adjusting the leakage inductance. The transformer 10 is designed to have a desired leakage inductance (around 100 ρH, about 70 to 130 ρH) in order to drive a converter or an inverter connected to the transformer 10 in a desired circuit and to reduce the switching loss of the converter or the inverter.

In a dual active bridge circuit configuration with an H bridge of a switching element (semiconductor element), it is necessary to adjust the phase difference, switching frequency, and power factor angle of the left and right switching elements in order to convert the power into desired power, and the transformer 10 requires a desired leakage inductance.

Generally, a cylindrical transformer has a small leakage inductance of around 25 ρH, and a vertical split transformer has a large leakage inductance of around 150 ρH. The transformer 10 described in Embodiment 1 may have a leakage inductance of an intermediate value between such a cylindrical transformer and a vertical split transformer.

The self-inductance can also be adjusted by arranging the inner primary coil 14a and the outer primary coil 14b to deviate in the up and down direction.

The outer primary coil 14b and the second primary coil 16 are arranged to overlap each other (without being in contact with each other via the lower support member 24).

The number of windings of the primary coil 14 is smaller than that of the second primary coil 16, and the cross-sectional area of the windings of the primary coil 14 is larger than that of the second primary coil 16.

The primary coil 14, the second primary coil 16, and the support member 24 are arranged symmetrically. The insulating material 22 is arranged on a portion where the resin material 26 covering the outer primary coil 14b on the left side and the resin material 26 covering the outer primary coil 14b on the right side are in contact with each other.

The transformer 10 is manufactured by the following procedure.
(1) The second primary coil 16 is arranged on the lower portion core 12.
(2) The inner primary coil 14a is arranged on the upper portion core 12 via the upper support member 24.
(3) The outer primary coil 14b is arranged on the lower portion core 12 where the second primary coil 16 is arranged, via the center support member 24 and the lower support member 24.
(4) The upper portion core 12 where the inner primary coil 14a is arranged, is arranged by being inserted from above into the lower portion core 12 where the second primary coil 16 and the outer primary coil 14b are arranged. In this case, the lower end of the inner primary coil 14a is fitted into a recess formed in the center support member 24. That is, the support member 24 holds the primary coil 14 at a predetermined position with respect to the core 12.

In this manner, the transformer 10 described in Embodiment 1 includes the core 12 formed of the magnetic body; the primary coil 14 wound around the core 12 and connected to the high-voltage side, the primary coil 14 having two coil layers of the inner primary coil 14a arranged more toward the inner peripheral side than the outer primary coil 14b and the outer primary coil 14b arranged more toward the outer peripheral side than the inner primary coil 14a; and the second primary coil 16 wound around the core 12 and connected to the low-voltage side, in which the outer primary coil 14b is arranged offset with respect to the inner primary coil 14a in the longitudinal direction of the axis of the core 12. That is, the outer primary coil 14b is arranged by deviating from the inner primary coil 14a in the downward direction of the axis of the core 12.

As a result, the transformer 10 has a large degree of design freedom for adjusting the leakage inductance, and suppresses the occurrence of partial discharge. That is, the transformer 10 appropriately holds the distance between the core 12 and the primary coil 14, and the distance between the primary coil 14 and the second primary coil 16, and solves the trade-off issue between ensuring the insulating properties and a large degree of design freedom for adjusting the leakage inductance.

With the transformer 10, it is possible to conform to arrangement constraints between components and ensure the insulating properties without increasing the size of the core 12, that is, by maintaining the size of the inner diameter of the core 12 (135 mm×60 mm) and the size of the outer diameter of the core 12 (175 mm×100 mm).

With the transformer 10, even in a case where the distance between the core 12 and the primary coil 14 and the distance between the primary coil 14 and the second primary coil 16 become smaller in accordance with the size reduction of the transformer 10, it is possible to increase the degree of design freedom for adjusting the leakage inductance while ensuring the insulating properties.

The transformer 10 can be driven at a radio frequency, and is effective for the SST in which the transformer 10 driven at the radio frequency and the semiconductor element are combined. In particular, it is effective for applications in which the arrangement space of the SST is limited.

As described above, according to Embodiment 1, it is possible to provide the transformer 10 having a large degree of design freedom for adjusting the leakage inductance while conforming to arrangement constraints between components in order to ensure the insulating properties of the transformer 10.

### Embodiment 2

Next, a vertical cross section of the transformer 10 described in Embodiment 2 will be described.

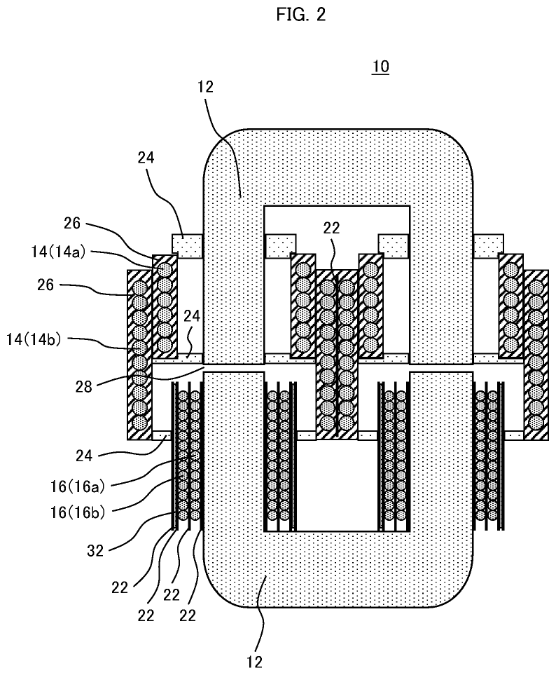

FIG. 2 is an explanatory diagram for describing the vertical cross section of the transformer 10 described in Embodiment 2.

The transformer 10 described in Embodiment 2 is different from the transformer 10 described in Embodiment 1 in the arrangement of the primary coil 14. In Embodiment 2, the difference from the transformer 10 described in Embodiment 1 will be described.

In the transformer 10, the inner primary coil 14a and the outer primary coil 14b have different numbers of windings, and the inner primary coil 14a and the outer primary coil 14b have different lengths in the up and down direction.

That is, in the transformer 10, the number of windings of the inner primary coil 14a is smaller than the number of windings of the outer primary coil 14b, and the length of the inner primary coil 14a in the up and down direction is shorter than the length of the outer primary coil 14b in the up and down direction.

In Embodiment 2, the overlapping portion between the inner primary coil 14a and the outer primary coil 14b is adjusted by making the numbers of windings of the inner primary coil 14a and the outer primary coil 14b different.

In this manner, it is possible to provide the transformer 10 having a large degree of design freedom for adjusting the leakage inductance by making the numbers of windings of the inner primary coil 14a and the outer primary coil 14b different to adjust the overlapping portion between the inner primary coil 14a and the outer primary coil 14b.

In a case where the transformer 10 described in Embodiment 2 is identical to the transformer 10 described in Embodiment 1 in that the number of the windings of the primary coil 14 (the total number of windings of the inner primary coil 14a and the outer primary coil 14b) is the same and the size of the inner diameter of the core 12 is the same, since the inner primary coil 14a is particularly supported by the central support member 24, in the transformer 10, the overlapping portion between the inner primary coil 14a and the outer primary coil 14b is increased, and the leakage inductance is increased.

That is, it is possible to provide the transformer 10 having a large degree of design freedom for adjusting the leakage inductance by adjusting the number of windings of the inner primary coil 14a and the outer primary coil 14b.

In this case, at the upper portion of the window of the core 12, the distance between the inner primary coil 14a and the core 12 can be increased. It is possible to suppress the fanning heat due to mutual heat generation between the inner primary coil 14a and the core 12.

The transformer 10 can be driven at a radio frequency, insulating properties are ensured, and thereby the heat dissipation is solved. The transformer 10 solves the trade-off issue between ensuring the insulating properties and a large degree of design freedom for adjusting the leakage inductance without excessively increasing the size (magnetic path length) of the core 12 of the transformer 10.

Note that the present invention is not limited to the above-described embodiments, and includes various modifications. For example, the respective embodiments described above are described specifically in order to describe the present invention for easy understanding, and are not necessarily limited to those having all the described configurations.

A part of the configuration of a certain embodiment can be replaced with a part of the configuration of another embodiment.

Further, the configuration of another embodiment can be added to the configuration of a certain embodiment. A part of the configuration of each embodiment can be deleted, and a part of another configuration can be added, and replaced with a part of another configuration.

### REFERENCE SIGNS LIST

10 transformer
12 core
14 primary coil
14a inner primary coil
14b outer primary coil
16 second primary coil
16a inner second primary coil
16b outer second primary coil
22 insulating material
24 support member
26 resin material
28 gap
32 contact preventing material

1. A transformer comprising:
a core formed of a magnetic body;
a primary coil wound around the core and connected to a high-voltage side, the primary coil having two coil layers of an inner primary coil and an outer primary coil arranged more toward an outer peripheral side than the inner primary coil; and
a second primary coil wound around the core and connected to a low-voltage side,
wherein the outer primary coil is arranged offset with respect to the inner primary coil in a longitudinal direction of an axis of a core.

2. The transformer according to claim 1, wherein the outer primary coil is arranged by deviating from the inner primary coil in a downward direction of an axis of a core.

3. The transformer according to claim 2, wherein
the core has a lower portion core and an upper portion core that are arranged facing each other to form a gap, and
the outer primary coil is arranged on an outer peripheral side of the gap to straddle the gap.

4. The transformer according to claim 3, wherein the inner primary coil is arranged above the gap.

5. The transformer according to claim 3, wherein the second primary coil is arranged below the gap.

6. The transformer according to claim 5, wherein the outer primary coil is arranged on an outer peripheral side of the second primary coil.

7. The transformer according to claim 6, wherein the number of windings of the inner primary coil is smaller than the number of windings of the outer primary coil.
